(19) United States
(12) Patent Application Publication
(10) Pub. No.: US 2025/0146226 A1
(43) Pub. Date: May 8, 2025

(54) STABILIZED SLURRY COMPOSITIONS HAVING ENHANCED BARRIER PROPERTIES

(71) Applicant: SOLENIS TECHNOLOGIES, L.P., Wilmington, DE (US)

(72) Inventors: Cecil Coutinho, Wilmington, DE (US); Kate Lusvardi, Chadds Ford, PA (US); Mike Thijs, Antwerp (BE)

(73) Assignee: SOLENIS TECHNOLOGIES, L.P., Wilmington, DE (US)

(21) Appl. No.: 18/938,299

(22) Filed: Nov. 6, 2024

Related U.S. Application Data
(60) Provisional application No. 63/596,324, filed on Nov. 6, 2023.

(51) Int. Cl. D21H 19/52; C09D 5/16; C09D 7/61; C09D 7/65; C09D 101/02; C09D 101/28; D21H 19/40; D21H 19/58; D21H 21/16

(52) U.S. Cl. CPC D21H 19/52; C09D 5/1656; C09D 7/61; C09D 7/65; C09D 101/02; C09D 101/28; D21H 19/40; D21H 19/58; D21H 21/16

(57) ABSTRACT

Provided is a stabilized slurry composition having enhanced barrier properties. The slurry includes a pigment having a BET surface area of greater than 15 m²/g and a composite of a microcrystalline cellulose and carboxymethyl cellulose. The slurry can be used to formulate barrier coatings to be applied to the surface of a paper or paperboard product to enhance and improve the barrier properties of the product.

### CROSS-REFERENCE TO RELATED APPLICATIONS

This application claims the benefit of U.S. Provisional application No. 63/596,324, filed 6 Nov. 2023, the entire contents of which are hereby incorporated by reference.

### TECHNICAL FIELD

Provided is a stabilized slurry that contains high aspect ratio pigment. This stabilized slurry when mixed with appropriate latexes will yield formulations having enhanced barrier properties. The stabilized slurry includes minerals and pigments, such as talc, having a BET surface area of greater than 15 m²/g; a Jennings and Parslow aspect ratio >30; and a composite of a microcrystalline cellulose and carboxymethyl cellulose creating a microcrystalline cellulose gel. The formulated and stabilized slurry can be applied to the surface of a paper or paperboard product to enhance and improve the barrier properties of the product and extend the shelf life of the final product.

### BACKGROUND

The current process relates to stable slurry compositions, such as talc slurries, which are used as a component in papermaking processes such as in barrier coatings formulations. The standard process of creating barrier coating compositions, for example with coatings containing talc, the talc is mixed into a latex(s) at extremely high shear conditions for between 10 to 60 minutes. This is not a robust process and results in significant product instability and variability. Critical variables affecting barrier coatings include the hydrophilicity of the rheology modifiers and stratification of the formulation due to the density mismatch between the pigments and latex binders. Additional variables include the age of the latex, temperature, impeller speed, flow profile (determined by reactor geometry and impeller position) and rate of talc addition.

Generally, the stabilization of pigmented slurries is needed in applications such as in drilling fluids in cracking, paint development and technical advances in cement slurries. Efforts to stabilize slurries used in these industries have included using extensive amounts of thickeners and rheology additives. These additives form a physical network with low aspect ratio fillers or non-lamellar particles. However, when using these additives, the slurries, such as talc slurries, results in a very high viscosity, making it more difficult to handle at a production facility. Additionally, these classical rheology modifiers have reduced effectiveness for high aspect ratio pigments, such as high aspect ratio talc that result in compaction of pigment within a few days.

It is well known in the field that high aspect ratio talc provides significantly better barrier properties to a paper or paperboard sheet than low aspect ratio talc. The current process being used to create a stable, high aspect ratio barrier coating formulation is to prepare and use the formulation immediately to avoid settling to take place. This process is done on-site and often leads to inconsistencies in the product. Still other techniques include a holding tank in which the formulation is continuously stirred.

Formulations have been described using a mixture of talc, chelating agents, and multivalent ions and stabilizing the mixture by adjusting the pH between about 10.2 and about 11.8. Other methods include formulations containing microfibrillated cellulose and inorganic particulate material with enhanced viscosity and tensile strength properties that are suitable for making paper or coating paper.

However, there is still a need to provide an aqueous talc slurry that has a reasonable shelf life with minimal compaction and/or soft sedimentation of the high aspect ratio talc.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a slurry comprising a talc having a BET surface area of greater than 15 m²/g in an amount of from about 50 wt. % to about 65 wt. % of the total weight of the slurry and a composite of a microcrystalline cellulose (MCC) and a carboxymethyl cellulose (CMC), which forms a microcrystalline cellulose gel (MCG).

The talc must also contain a Jennings and Parslow aspect ratio >30 where the median particle size as measured by sedigraph and laser and the Jennings and Parslow aspect ratio is computed as follows:

$$\frac{3 π}{2} {( \frac{{D}_{50} Laser}{{D}_{50} Sedi graph} )}^{2}$$

Also provided is a process to produce paper or board with improved barrier properties, such as liquid and vapor barrier properties. The slurry as described above is applied to the surface of the paper or paper board.

### BRIEF DESCRIPTION OF THE DRAWINGS

The present disclosure will hereinafter be described in conjunction with the following drawing figures, wherein like numerals denote like elements, and wherein:

FIG. 1, depicts the better water barrier properties as measured by the standard 30 minute water Cobb test (Tappi Method T441) where the MCG outperforms all the standard rheology modifiers and thickeners used for pigmented slurries.

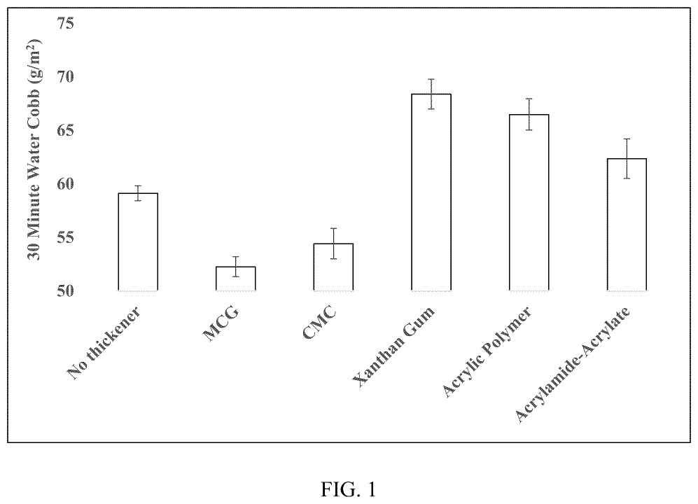

FIG. 2, shows settling behavior of talc slurries at high solids content of 62% total solids with a viscosity of ˜1000 cP. The MCG rheology modifier significantly outperforms the typical rheology modifiers and thickeners used in the industry.

FIG. 3, shows settling behavior of talc slurries at solids content of 52% total solids with a viscosity of ˜1000 cP. The MCG rheology modifier significantly outperforms the typical rheology modifiers and thickeners used in the industry.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, the term “paper” refers to paper products including tissue paper, paper towels and paper board.

Provided is a slurry that includes talc having a BET surface area of greater than 15 m²/g, which is combined with a microcrystalline gel (MCG), which is a composite consisting of microcrystalline cellulose (MCC) and carboxymethyl cellulose (CMC). The microcrystalline cellulose and carboxymethyl cellulose (CMC) together forming the microcrystalline cellulose gel (MCG). Although not to bound by theory, the MCG forms a 3D elastic gel-network in which the talc particles are prevented from flocculating and thus less sedimentation. This ensures the talc slurry to be stable for longer time periods (at least 60 days) and minimizes the effort of using it in production. In addition, the final coating product will also be more stable for longer time periods and the talc particles are better dispersed in the coating layer, which ensures the optimal barrier properties of the coating wherein the MCG yields the best water hold-out when formulated and coated on a sheet.

In some aspects of the slurry, the talc is a lamellar talc in an amount of from about 40 wt. % to about 75 wt. %, or from about 50 wt. % to about 65 wt. % of the slurry.

In some aspects of the slurry, microcrystalline cellulose gel comprises microcrystalline cellulose and carboxymethyl cellulose in a molar ratio of from about 1:1 to about 1:4.

In still other aspects of the slurry composition, the slurry further includes additional additives, such as xanthan gum, sodium alginate, acrylates, or the formulation can contain combinations of additives. The additives can comprise from about 0.5 wt. % to about 5 wt. % of the slurry.

In yet other aspects of the slurry composition, the slurry can optionally include dispersant and wetting agents well known in the art, such as non-ionic surfactants

In yet other aspects of the slurry, the slurry has a pH of from about 6 to about 11.

In other aspects, the slurry remains in suspension as determined visually after storage at 25° C. temperature for at least 60 days.

Also provided, is a process for the production of paper or board with improved barrier properties.

The process includes the steps of providing a paper or paper board barrier coating product, and applying to at least one surface of the paper or paper board a slurry composition comprising an aqueous pigmented slurry, containing a microcrystalline cellulose gel, and a polymeric binder emulsion.

In some aspects of the process, the pigment is a talc, such as a lamellar talc, having a BET surface area of greater than 15 m²/g and with a Jennings and Parslow aspect ratio greater than 30.

In some aspects of the process, the pigment comprises from about 40 wt. % to about 75 wt. %, or from about 50 wt. % to about 65 wt. % of the slurry composition.

In yet other aspects of the process, the microcrystalline gel of the slurry is a composite consisting of microcrystalline cellulose and carboxymethyl cellulose.

In some aspects of the process, the molar ratio of microcrystalline cellulose to carboxymethyl cellulose is from about 1:1 to about 1:4.

In some aspects of the process, the polymeric binder emulsion can be chosen from styrene butadiene, styrene acrylate, polyethylene, polypropylene, polyethylene oxide, polyacrylate, polyvinyl alcohol, polyvinyl acetate, polyvinyl amine, and combinations thereof.

In other aspects of the process, the pigment can be chosen from talc, kaolin, bentonite, calcium carbonate, mica, and combinations thereof.

In yet other aspects of the process, a barrier coating is applied on the surface of a substrate, which is comprised of a polymeric content from about 30 wt. % to about 70 wt. % and a pigmented slurry content from about 30 wt. % to about 70 wt. % based on total dry weight of the coating, or a polymeric content from about 30 wt. % and 50% and a pigmented slurry content from about 50 wt. % and 70 wt. % based on total dry weight of the coating, or a polymeric content from about 30 wt. % and 40 wt. % and a pigmented slurry content from about 60 wt. % and 70% based on total dry weight of the coating.

The rheology modifier ranged from about 0.03 wt. % to about 3 wt. % based on total dry weight of the dry talc present.

In other aspects of the process, the pigmented slurry comprises of a pigment, water, polyacrylic acid, microcrystalline cellulose gel, rheology modifiers, and combinations thereof.

In other aspects of the process, the slurry further comprises additional additives such as chosen from xanthan gum, sodium alginate, acrylates, and combinations thereof.

In some aspects of the process, the slurry is sheared for about 20 minutes or longer, after which a latex or combination of latexes are added to create a water-based barrier coating formulation that can be applied to the surface of the paper or paper board.

### EXAMPLES

The following studies were accomplished using a range of rheology modifiers. The studies were done in an effort to optimize the inorganic talc dispersion, to improve their shelf-life, reduce talc sedimentation and mitigate coalescence.

### Example 1—Settling Study of a Talc/Alginate Formulations

In this study 303 grams (g) talc, 2 grams (g) sodium acrylate, 4.7 grams (g) non-ionic wetting agent (Hydropalat™ WE3197, Dow Chemical Co.) and 1 gram (g) of sodium alginate were added to a one liter (l) vessel/reactor containing 189 grams (g) of water and mixed/sheared for 15 minutes. The formulation/mixture was transferred to a storage vessel and allowed to stand over 60 days.

### Example 2—Settling Study of a Talc/Acrylamide-Acrylate Formulations

The same procedures was followed as in Example 1, except the alginate was replaced with an acrylamide-acrylate composition. As indicated in Table 1, the formulation containing Sterocoll™ FS and CHP 701 (aqueous, anionic dispersion of a copolymer of acrylate and carboxylic acids) continued to thicken over time that led to products gelling at long storage intervals. This resulted in a compacted talc layer at the bottom of the storage vessel, which was difficult to re-incorporate into a uniform slurry mixture.

### Example 3—Settling Study of Talc/Carbohydrate-Based Formulations

In this study, the same procedure used in the previous examples were used, except that carbohydrate-based thickeners (CMC, Xanthan) replaced the alginate, and acrylamide-acrylic, compositions. However, as can be seen from the results shown in Table 1, the talc/carbohydrate formulations were not shear stable, had a reduced shelf life, and worked within a limited range of talc solids.

### Example 4—Settling Study of Talc/Microcrystalline Cellulose (MCC) Co-Processed with Carboxymethyl Cellulose (CMC) Formulations

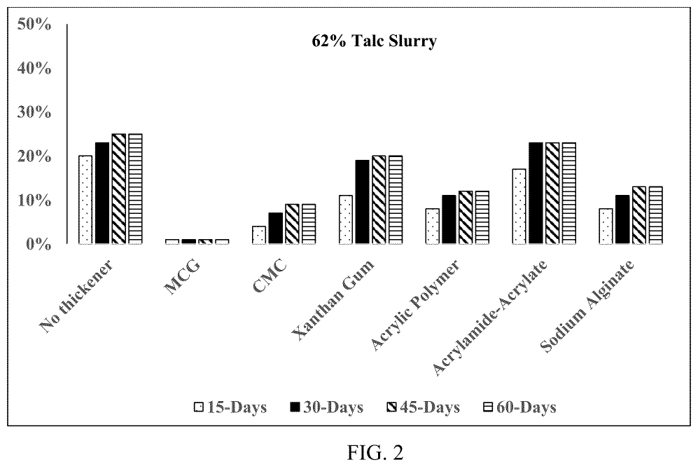

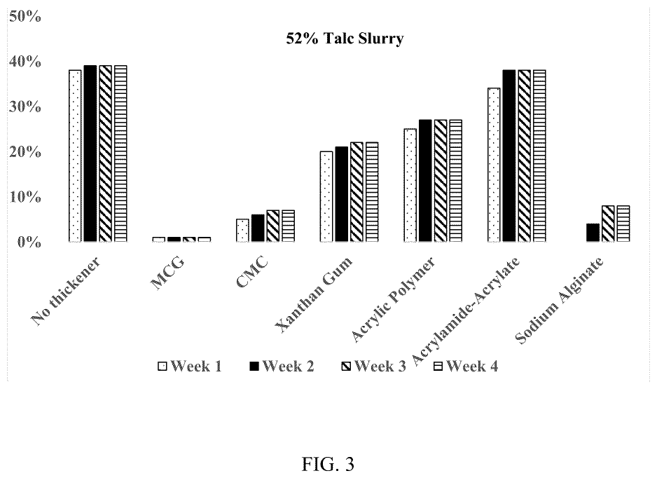

In this study, a lamellar talc slurry was combined with a microcrystalline cellulose (MCC) co-processed with CMC. The talc slurry was prepared having a solids of from 52 wt. % (FIG. 2) to about 63 wt. % (FIG. 3), and a BET surface area of greater than 15 m²/g. The slurry was stabilized with a microcrystalline cellulose gel (MCG). The MCG is a composite consisting of microcrystalline cellulose (MCC) and sodium carboxymethyl cellulose (Na-CMC). The microcrystalline cellulose and carboxymethyl cellulose (CMC) together forming the microcrystalline cellulose gel (MCG). Although not to bound by theory, the MCG forms a 3D elastic gel-network in which the talc particles are prevented from flocculating and thus less sedimentation. This ensures the talc slurry to be stable for longer time periods (>60 days) and minimizes the effort of using it in production. In addition, the final coating product will also be more stable for longer time periods and the talc particles are better dispersed in the coating layer, which ensures the optimal barrier properties of the coating wherein the MCG yields the best water hold-out when formulated and coated on a sheet.

TABLE 2
Settling Characteristics of a 52% Solids Talc Slurry

| | Description | Week | Week | Week | Week | Solids |
|---|---|---|---|---|---|---|
| Sample | Talc Slurry | 1 | 2 | 3 | 4 | (%) |
| 1 | No thickener | 38% | 39% | 39% | 39% | 52% |
| 2 | MCG | 1% | 1% | 1% | 1% | 52% |
| 3 | CMC | 5% | 6% | 7% | 7% | 52% |
| 4 | Xanthan Gum | 20% | 21% | 22% | 22% | 52% |
| 5 | Acrylic Polymer | 25% | 27% | 27% | 27% | 52% |
| 6 | Acrylamide-Acrylate | 34% | 38% | 38% | 38% | 52% |
| 7 | Sodium Alginate | 0% | 4% | 8% | 8% | 52% |

TABLE 3
Settling Characteristics of a 62% Solids Talc Slurry

| | Description | 15- | 30- | 45- | 60- | Solids |
|---|---|---|---|---|---|---|
| Sample | Talc Slurry | Days | Days | Days | Days | (%) |
| 1 | No thickener | 20% | 23% | 25% | 25% | 62% |
| 2 | MCG | 1% | 1% | 1% | 1% | 62% |
| 3 | CMC | 4% | 7% | 9% | 9% | 62% |
| 4 | Xanthan Gum | 11% | 19% | 20% | 20% | 62% |
| 5 | Acrylic Polymer | 8% | 11% | 12% | 12% | 62% |
| 6 | Acrylamide-Acrylate | 17% | 23% | 23% | 23% | 62% |
| 7 | Sodium Alginate | 8% | 11% | 13% | 13% | 62% |

Results shown in Tables 2 and 3 above, indicates that MCG added to a talc slurry reduced the settling tendency of the talc slurry at both high (62%) and low talc solids (52%) while maintaining a viscosity of about 1000 cP in both samples.

The talc slurries that included enhanced talc stability over traditional carbohydrate-based thickeners (CMC, HEMC, Xanthan) with significantly reduced settling and caking at the following conditions: Increased range of talc solids: 50-65% vs 60-65%. New composition provides enhanced talc stability at higher manufacturing shear rates with little stability loss at >10⁶ s⁻¹.

Example 5-Water absorptive study of coated paper/paperboard substrates using coating formulation consisting of stabilized pigment and latex

In this study, the slurry formulations from example 1-4 are each mixed with 319 grams (g) of a styrene butadiene latex (Tykote 1004). The resulting coating formulation is applied on a 80 GSM paper use a benchtop rod coater where a 10 GSM coating is applied. The paper and coating are dried in the oven at 95 C for 2 hours. The water absorption is measured by Tappi method T441.

TABLE 3
Water Absorption Study of Coated Paper Using
Latex and a 62% Solids Talc Slurry

| | | Cobb Test (30- | Standard |
|---|---|---|---|
| Sample No. | Talc Slurry Additives | Minute Water) | Deviation |
| Sample 1 | No thickener | 59.1 | 0.70 |
| Sample 2 | MCG | 52.2 | 0.93 |
| Sample 3 | CMC | 54.4 | 1.42 |
| Sample 4 | Xanthan Gum | 68.4 | 1.39 |
| Sample 5 | Acrylic Polymer | 66.5 | 1.46 |
| Sample 6 | Acrylamide-Acrylate | 62.3 | 1.85 |

As shown in Table 3, Cobb test results indicated the formulation that included the MCG provided the best resistance to water absorption followed by the formulation containing CMC. The other formulations provided significant improvement over the formulation with no thickener in terms of settling behavior but exhibited worse water absorption.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

We claim:

1. A slurry composition comprising:
a pigment having a BET surface area of greater than 15 m²/g and an aspect ratio greater than 30; a microcrystalline cellulose gel; and
water.

2. The slurry composition according to claim 1, wherein the pigment comprises from about 40 wt. % to about 75 wt. %, or from about 50 wt. % to about 65 wt. % of the total weight of the slurry.

3. The slurry composition according to claim 1, wherein the pigment is chosen from talc, kaolin, bentonite, calcium carbonate, mica, and combinations thereof.

4. The slurry composition according to claim 3, wherein the pigment is a lamellar talc.

5. The slurry composition according to claim 1, wherein the microcrystalline cellulose gel is composite consisting of microcrystalline cellulose (MCC) and carboxymethyl cellulose.

6. The slurry composition according to claim 5, wherein the molar ratio of microcrystalline cellulose to carboxymethyl cellulose is from about 1:1 to about 1:4.

7. The slurry composition according to claim 1, further comprising one or more additives.

8. The slurry composition according to claim 7, wherein the additive is chosen from xanthan gum, sodium alginate, acrylates, and combinations thereof.

9. The slurry composition according to claim 7, wherein the additives comprise from about 0.5 wt. % to about 5 wt. % of the total weight of the slurry.

10. The slurry composition according to claim 1, wherein a slurry comprising from about 40 wt. % to about 75 wt. % pigment solids remains in suspension as determined visually after storage at 25° C. temperature for at least 60 days.

11. The slurry composition according to claim 10, wherein the slurry comprises about 50 wt. % pigment solids and remains in suspension as determined visually after storage at 25° C. temperature for at least 60 days.

12. A process for the production of paper or board with improved barrier properties, said method comprising the steps of:
providing a paper or board product having a surface, and
applying a slurry composition comprising a pigment having a BET surface area of greater than 15 m²/g and an aspect ratio greater than 30; a microcrystalline cellulose gel; and a polymeric binder emulsion.

13. The process according to claim 12, wherein the pigment is chosen from talc, kaolin, bentonite, calcium carbonate, mica, and combinations thereof.

14. The process according to claim 12, wherein the pigment comprises from about 40 wt. % to about 75 wt. %, or from about 50 wt. % to about 65 wt. % of the total slurry composition.

15. The process according to claim 12, wherein the microcrystalline gel is a composite consisting of microcrystalline cellulose and carboxymethyl cellulose.

16. The process according to claim 12, wherein the polymeric binder emulsion can be chosen from styrene butadiene, styrene acrylate, polyethylene, polypropylene, polyethylene oxide, polyacrylate, polyvinyl alcohol, polyvinyl acetate, polyvinyl amine, and combinations thereof.

17. The process according to claim 12, wherein the slurry composition further comprises one or more additives.

18. The process according to claim 12, wherein the slurry composition is sheared for at least 10 minutes prior to being applied to the surface of the paper or board.

19. The process according to claim 12 wherein the slurry composition is applied to the paper or paperboard via spraying, rotogravure, rod applicator, blade applicator, and curtain coating.

20. The process according to claim 12, wherein the paper or board having the slurry composition applied to its surface has improved liquid and vapor barrier properties of approximately 13% improvement using the 30 minute water cobb test when compared with paper or paper board without the slurry composition.
